(19) United States
(12) Patent Application Publication
(10) Pub. No.: US 2012/0189392 A1
(43) Pub. Date: Jul. 26, 2012

(54) POWER SUPPLY DEVICE FOR AN ELECTROMAGNETIC BASE OF A DRILL, PARTICULARLY OF AN ELECTRIC DRILL

(75) Inventors: Zbigniew Golabiewski, Bialystok (PL); Adam Czyzewski, Bialystok (PL)

(73) Assignee: PROMOTECH SP. Z O.O., Bialystok (PL)

(21) Appl. No.: 13/300,590

(22) Filed: Nov. 20, 2011

(30) Foreign Application Priority Data
Jan. 20, 2011 (PL) P.393693

(51) Int. Cl. B23B 47/00; H02J 9/00

(52) U.S. Cl. 408/76; 307/64

(57) ABSTRACT

A power supply device for an electromagnetic base of a drill, particularly of an electric drill, used primarily for steel structure drilling including a drill controller. The drill controller (S) through a power supply detector (D) connected to supply terminals of the electromagnetic base (PD) is connected with a converter (P) which in case of a loss of line voltage (AC), after automatic activation, supplies during a time (t) a standby voltage (UPD) of a value enabling the generation of a base clamping force (PD).

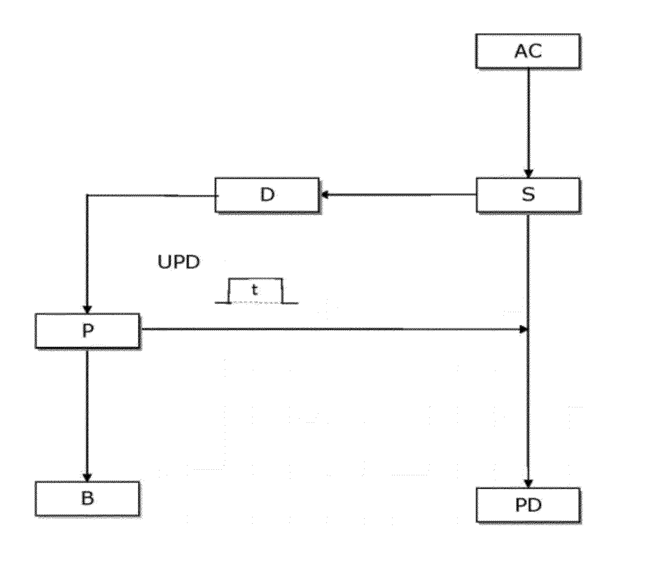

### CROSS-REFERENCE TO RELATED APPLICATIONS

Pursuant to 35 U.S.C. §119 and the Paris Convention Treaty, this application claims the benefit of Polish Patent Application No. P.393693 filed Jan. 20, 2011, the contents of which are incorporated herein by reference in their entirety.

### BACKGROUND OF THE INVENTION

1. Field of the Invention

This invention relates generally to a power supply device for an electromagnetic base of a drill, particularly of an electric drill, the drill being used primarily for steel structure drilling.

2. Description of the Related Art

In horizontal drilling of steel wall structures or in drilling holes in steel parts of ceilings, drills provided with an electromagnetic base are known and commonly used. High drilling accuracy and efficiency in such drills is achieved by fixing the drill drive on a housing which is mounted on an electromagnetic base. Manual or automatic feeding of the drill drive facilitates fast and precise drilling.

The electromagnetic base includes a strong electromagnet which clamps the device to steel structures in which assembling holes are to be drilled. The electromagnetic base contains, in its bottom part, electromagnets designed for clamping to the work piece by means of magnetic force originating from such electromagnets.

In related art solutions, during drilling, the electric drill and the electromagnetic base are energized by line current at all times. When power is lost, force which clamps the electromagnetic base of the electric drill vanishes. Such a situation is particularly dangerous and constitutes a serious risk of accidents because it can result in disconnection of the base and the drilling device from the work piece. That is why drills are provided, as a safeguard in case of voltage loss, with special chains or belts protecting against detachment and uncontrolled fall of the device.

### SUMMARY OF THE INVENTION

In one aspect, this invention provides a power supply device for an electromagnetic base of a drill, particularly of an electric drill, which supply preserves the operation of the electromagnetic base in case of a loss of line voltage.

The power supply device is provided with a drill controller. The drill controller is connected, through a power supply detector, with a converter whose output is connected to the power supply terminals of the electromagnetic base to which, in case of a loss of line voltage, after automatic activation of the converter for a certain time, a standby voltage of a value enabling the generation of a force clamping the base is supplied. The time is chosen such as to enable the operator to safely finish the work and to secure the device.

Preferably the converter has a battery charge level indicator which indicates the value of supply voltage.

If the voltage supplied to the converter drops below the threshold of its safe operation, then such state is signaled by the system.

The power supply device of an electromagnetic base of a drill, particularly of an electric drill, at the moment of a loss of external voltage supplied to the entire device delivers voltage to the electromagnetic base, thus reducing the risk of detachment of the base from the work piece. A fast, automatic activation of the converter allows for a continuous and reliable power supply to the electromagnet, whereas the energy stored in a miniature set of batteries is sufficient for an appropriately long power supply of the electromagnetic base.

In another aspect of the invention provided is a power supply device for an electromagnetic base of a drill in combination with the electromagnetic base.

In one embodiment of the invention, the combination comprises: an electromagnetic base (PD) having supply terminals; a drill controller (S); a power supply detector (D); and a converter (P).

In a class of this embodiment, the drill controller (S) is directly connected to the supply terminals of electromagnetic base (PD); the drill controller (S) is directly connected to the power supply detector (D); the power supply detector (D) is directly connected to the converter (P); and the converter (P) is directly connected to the supply terminals of the electromagnetic base (PD).

In a class of this embodiment, the converter (P) comprises batteries which store energy that allow the converter (P) to deliver to the electromagnetic base (PD) a standby voltage (UPD).

In a class of this embodiment, when an external line voltage (AC) supplying power to the drill controller (S) is lost, the converter (P) is activated and supplies for a time (t) a standby voltage (UPD) having a value that enables the generation of a base clamping force by the electromagnetic base (PD).

### BRIEF DESCRIPTION OF THE DRAWINGS

The invention is described hereinafter with reference to accompanying drawings, in which the sole figure shows a block diagram of a power supply device for an electromagnetic base of a drill, particularly of an electric drill.

### DESCRIPTION OF A PREFERRED EMBODIMENT OF THE INVENTION

With reference to the sole figure, the power supply device for an electromagnetic base of a drill, particularly of an electric drill, provided with a drill controller is connected through a power supply detector D with a converter P. The output of the converter P is connected to terminals supplying voltage to the electromagnetic base PD. Switching on the main switch of the device results in voltage being supplied to the electromagnetic base PD by the system of a controller S provided with a voltage loss detector D.

When the external line voltage AC is lost, an automatic activation of the converter P which supplies during the time t, limited to 180 seconds, a standby voltage UPD of a value enabling the generation of a base clamping force PD. The time is chosen in such a way as to enable the operator to safely finish the work and secure the device. If the voltage supplied to the converter P drops below the threshold of its safe operation, then such state is signaled by a system battery charge level indicator B.

What is claimed is:

1. A power supply system for an electromagnetic base of a drill which preserves the operation of the electromagnetic base in case of a loss of external line voltage, the power supply being provided with a drill controller, wherein the drill controller (S) through a power supply detector (D) connected to supply terminals of the electromagnetic base (PD) is connected with a converter (P) which in case of a loss of line voltage (AC) after automatic activation supplies during a time (t) a standby voltage (UPD) of a value enabling the generation of a base clamping force (PD).

2. The power supply of claim 1, wherein the converter (P) has a battery charge level indicator (B) which indicates the value of supply voltage.

3. A power supply device for an electromagnetic base of a drill in combination with the electromagnetic base, the combination comprising: an electromagnetic base (PD) having supply terminals; a drill controller (S); a power supply detector (D); and a converter (P); wherein said drill controller (S) is directly connected to said supply terminals of electromagnetic base (PD); said drill controller (S) is directly connected to said power supply detector (D); said power supply detector (D) is directly connected to said converter (P); and said converter (P) is directly connected to said supply terminals of the electromagnetic base (PD).

4. The power supply device of claim 3, wherein when an external line voltage (AC) supplying power to said drill controller (S) is lost, said converter (P) is activated and supplies for a time (t) a standby voltage (UPD) having a value that enables the generation of a base clamping force by said electromagnetic base (PD).

5. The power supply device of claim 4 further comprising a battery charge level indicator (B) which indicates the value of said external line voltage (AC) or said standby voltage (UPD).
